(19) United States
(12) Patent Application Publication
(10) Pub. No.: US 2026/0309170 A1
(43) Pub. Date: Oct. 8, 2026

(54) ACTUATOR UNIT, SYSTEM AND OPERATING METHOD

(71) Applicant: KNORR-BREMSE SYSTEME FÜR NUTZFAHRZEUGE GMBH, München (DE)

(72) Inventors: Heinz Henning Hoppmann, München (DE); Klaus Peterreins, München (DE); Kai Hölters, München (DE); Tobias Imgold, München (DE)

(21) Appl. No.: 19/474,805

(22) PCT Filed: Mar. 21, 2024
(86) PCT No.: PCT/EP2024/057529

§ 371 Date: Oct. 13, 2025

(30) Foreign Application Priority Data
Apr. 14, 2023 (DE) 10 2023 109 481.5

(51) Int. Cl. F15B 21/041; B62D 5/08; B62D 5/12; F15B 15/14

(52) U.S. Cl. CPC F15B 21/041; B62D 5/12; F15B 15/1428; B62D 5/08

(57) ABSTRACT

An actuator unit, in particular a steering actuator unit, includes at least one fluid cylinder, at least one backup valve unit and at least one filter unit, wherein the fluid cylinder has a first cylinder chamber and a second cylinder chamber and wherein at least one first fluid connection can be formed between the first and second cylinder chambers, in particular at least temporarily. The first fluid connection extends via the filter unit and the backup valve unit, wherein a flushing function can be provided by means of the first fluid connection.

The present invention relates to an actuator unit, in particular a steering actuator unit, as well as to a motor vehicle and to a method for operating an actuator unit of this kind or a motor vehicle of this kind.

In fluid cylinders, over the course of operation, contaminants and residues may settle or form within the operating fluid, either due to the introduction of contaminants from outside the fluid circuit or, for example, due to the aging of the fluid.

In particular, residues of this kind may form and settle in dead spaces of fluid cylinders and may suddenly become detached and be carried further into the connected fluid circuit.

Consequently, these residues or contaminants can not only impair the operation of the fluid cylinder, e.g. by adversely affecting friction properties within the fluid cylinder, causing reduced performance in terms of fluid pressure (build-up), and/or resulting in the transfer of residues into the rest of the fluid circuit, but may also, in particular, lead to complete failure of the fluid cylinder or the connected fluid circuit, for example due to clogging or jamming of fluid lines, fluid connections, pumps, and/or valves.

To avoid downtimes of this kind and additional maintenance work, as well as component failures, contaminants or residues of this kind must be removed from the fluid cylinder or from the fluid circuit, in particular from a bidirectional fluid circuit.

The object of the present invention is to further develop an actuator unit of the kind referred to above in an advantageous manner, in particular in such a manner that a fluid cylinder can be cleaned or flushed in a cost-effective, simple, and reliable manner, in particular so that contaminants or residues can be removed from the (operating) fluid, preferably without disassembling the actuator unit. Furthermore, an object is to provide a motor vehicle with an actuator unit of this kind, as well as a method for operating same.

This object is achieved according to the invention by an actuator unit having the features of claim 1, as well as a motor vehicle as claimed in claim 11 and a method as claimed in claim 12.

According to this, it is provided that an actuator unit, in particular a steering actuator unit, comprises at least one fluid cylinder, at least one backup valve unit, and at least one filter unit, wherein the fluid cylinder has a first cylinder chamber and a second cylinder chamber. At least one first fluid connection can be formed, in particular at least temporarily formed, between the first and second cylinder chambers, wherein the first fluid connection extends via the filter unit and the backup valve unit, wherein a flushing function can be provided via the first fluid connection—in particular for flushing out contaminants and/or deposits—for the first cylinder chamber in a first flow direction of the first fluid connection and/or for the second cylinder chamber in a second flow direction of the first fluid connection.

The invention is based on the fundamental idea that the cylinder chambers can be cleaned with the help of the fluid flow, whereby contaminants, residues, or deposits in the respective cylinder chamber are dissolved and/or flushed out. By means of an at least temporary first fluid connection between the two cylinder chambers of the fluid cylinder, a cleaning element, such as a filter unit, can be interposed in this case to route the operating fluid/fluid between the two cylinder chambers through the filter unit, and in this way extract or filter out contaminants or residues from the fluid. In particular, the first fluid connection should be capable of being temporarily established in this case by means of a backup valve unit, wherein the filter unit is arranged along the first fluid connection in an inflow to the backup valve unit. The filter unit can therefore exert a cleaning effect on the fluid during a cleaning flushing process. Furthermore, in this way, the backup valve unit can be protected, in at least a first and/or second flow direction, from contaminants or residues, in particular from one of the cylinder chambers of the fluid cylinder.

At least a first fluid connection can be formed between the first and second cylinder chamber, in particular formed at least temporarily, wherein the first fluid connection extends via the filter unit and the backup valve unit.

Accordingly, it is preferably provided that the first fluid connection between the first and second cylinder chamber can be established, at least temporarily, by means of the backup valve unit.

In particular, the first fluid connection may be established exclusively for the purpose of providing a flushing/cleaning function, while a separate first fluid connection ensures the normal and intended operation of the actuator unit or is not (substantially) impaired.

This allows a cleaning or flushing function to be provided efficiently and in a targeted manner for the first and/or second cylinder chamber, by making the first fluid connection producible and enabling the fluid of the actuator unit to be cleaned via the filter unit.

It is also conceivable that the filter unit is provided along the first fluid connection in such a manner that the filter unit is arranged between the backup valve unit and the first cylinder chamber or second cylinder chamber, in particular between the backup valve unit and the respective cylinder chamber. In particular, the first fluid connection may form a series arrangement of the filter unit with the backup valve unit.

Experience has shown that more or heavier contamination and/or residues accumulate in one of the first or second cylinder chambers. Preferably, the filter unit can be arranged along the first fluid connection between the backup valve unit and whichever of the first and second cylinder chambers (based on experience) contains more or heavier contamination, residues, and the like. Alternatively, the filter unit may be arranged in any desired position in relation to the backup valve unit.

In this way, the backup valve unit can be at least partially protected against the flow of contaminants, residues, deposits, and the like, by means of the filter unit.

Furthermore, it may be provided that the fluid cylinder comprises a first fluid port and a first flushing port, as well as a second fluid port and a second flushing port, wherein the first and second flushing ports are provided to form the first fluid connection.

During a flushing operation, the fluid can flow between the first and second cylinder chambers via the first and second flushing ports and the first fluid connection.

In this context, (additional) fluid can be introduced via the first fluid port into the first cylinder chamber, in order to be transferred via the first flushing port along the first fluid connection to the second cylinder chamber via the second flushing port, in particular for flushing or cleaning the first cylinder chamber.

Alternatively, (additional) fluid can be introduced via the second fluid port into the second cylinder chamber, in order to be transferred via the second flushing port along the first fluid connection to the first cylinder chamber via the first flushing port, in particular for flushing or cleaning the second cylinder chamber.

Fluid can be introduced via the first or second fluid port of the cylinder chambers, in order to clean or flush the respective cylinder chamber, wherein the fluid is cleaned and filtered along the first fluid connection with the help of the filter unit.

Furthermore, it is possible that a second fluid connection is provided between the first and second cylinder chambers, wherein the second fluid connection comprises a throttle unit.

In particular, the second fluid connection may be provided to create or enable a pressure equalization between the first and second cylinder chambers. By means of the throttle unit, a gradual or continuously adjustable pressure equalization over a period of time can be achieved.

In the context of the present invention, the throttle unit acts as a low-pass filter. Consequently, the fluid pressure in the first or second cylinder chamber can be increased in the short term, in particular also for flushing or cleaning the cylinder chamber. By contrast, the second fluid connection with the throttle unit causes a pressure equalization when a long-lasting pressure difference exists between the two cylinder chambers.

Furthermore, it may be provided that at least the first cylinder chamber or the second cylinder chamber comprises a throttle port, so that the second fluid connection is preferably formed between the throttle port and the first or second flushing port.

The second fluid connection can be connected to at least one of the two cylinder chambers via a section of the first fluid connection. Preferably, at least one of the two cylinder chambers comprises a throttle port for forming the second fluid connection.

In this way, at least a partial hydraulic separation of the first and second fluid connection is possible.

In particular, an advantageous distribution or extension of the increased fluid pressure during flushing or cleaning can be achieved, in that the second fluid connection is connected to one of the cylinder chambers only via a section of the first fluid connection.

Alternatively, the first and second cylinder chambers may each comprise a throttle port for forming the second fluid connection. Furthermore, it is possible for the backup valve unit to be a spring-loaded solenoid valve, wherein the backup valve unit comprises at least a first switching position, preferably a flow position, and a second switching position, preferably a blocking position.

In the first switching position, the first fluid connection can be established, at least temporarily and in particular in a targeted or controlled manner, by means of the backup valve unit. In the second switching position, the first fluid connection can be, or can be brought into, a disconnected state.

Preferably, it can be provided that the first switching position represents the relaxed spring position, whereas the actuator spring of the solenoid valve is tensioned or loaded in the second switching position and can be held in that position by the energized solenoid valve.

By means of the backup valve unit in the form of a spring-loaded solenoid valve, a fluid flow or flow-through along the first fluid connection can be ensured in the event of a fault, i.e. in particular in the event of a power supply failure.

Furthermore, it is possible for the fluid cylinder to be designed as a double-acting fluid cylinder, in particular as a double-acting piston cylinder.

Preferably, both cylinder chambers of the fluid cylinder are cleanable or flushable, so that by means of the present invention, contamination or residues can be removed from both the first and the second cylinder chamber.

Preferably, a main flushing direction can be predetermined by arranging the filter unit upstream of the backup valve unit in the associated flow direction along the first fluid connection. The main flushing direction can in particular be provided for flushing or cleaning (primarily) the cylinder chamber that typically accumulates greater or more contamination or residues. In this way, the backup valve unit can be protected from at least a majority of the contamination or residues, as these can be intercepted by the filter unit before they flow through the backup valve unit.

Alternatively, it may be provided that at least one filter unit is arranged on each side of the backup valve unit along the first fluid connection.

It is also possible for the actuator unit to further comprise a rectifier circuit, wherein the backup valve unit and/or the filter unit is/are arranged within the rectifier circuit, in particular so that a flushing function for the first and/or second cylinder chamber can be provided along the first fluid connection. Furthermore, it is conceivable that the rectifier circuit is configured within the first fluid connection as a half-wave rectifier circuit, to provide a flushing function for one of the first or second cylinder chambers, or as a full-wave rectifier circuit, to provide a flushing function for the first and second cylinder chambers.

By means of the rectifier circuit, it can in particular be provided that at least primarily one of the two cylinder chambers can be flushed or cleaned, or that both cylinder chambers can be cleaned. For this purpose, the rectifier circuit may be configured in such a manner that a fluid pressure or fluid flow for cleaning or flushing, starting from the first and/or second cylinder chamber, is routed via the at least one filter unit.

Alternatively, the rectifier circuit can be configured in such a manner that, for example, fluid pressure in only the first cylinder chamber is specifically routed through the filter unit, so that in particular, or exclusively, the first cylinder chamber can be cleaned. To implement the respective alternatives, the rectifier circuit may be configured, for example, as a half-wave or as a full-wave rectifier circuit, for example in the form of a so-called Graetz circuit.

In this way, specific cleaning of the individual cylinder chamber(s) is made possible.

It can further be provided that the rectifier circuit is configured with a plurality of check valves, in such a manner that the flushing function can be predetermined in the first and/or second flow direction along the first fluid connection.

By means of the plurality of check valves, the flow direction along the first fluid connection, in particular within the rectifier circuit and/or through the at least one filter unit, can be predetermined.

A targeted flow control and cleaning or filtration of the operating fluid within the rectifier circuit or along the first fluid connection is possible.

According to an independent aspect, a motor vehicle, in particular a commercial vehicle, comprising at least one actuator unit according to the present invention, is also provided.

Preferably, it can be provided that for each actuator unit, one first fluid connection with at least one filter unit, within the meaning of the present invention, is provided. In particular, the contamination or residues of the individual actuator units, depending, for example, on their area of application and/or frequency of use, can be filtered or cleaned or flushed (out) independently of one another.

According to a further independent aspect of the invention, a method for operating at least one actuator unit or a motor vehicle according to the present invention is also provided which comprises the following steps:
establishing the first fluid connection between the first and second cylinder chambers, in particular by means of switching the backup valve unit from the second switching position into the first switching position;
supplying a predeterminable amount of fluid via at least the first or second fluid port into the first or second cylinder chamber, so that a flushing function is provided via the first fluid connection in the first or second flow direction, in particular for flushing or cleaning the first and/or second cylinder chamber (120; 130).

Preferably, the switching of the backup valve unit can be carried out in the manner of a spring-loaded switching operation, so that, in the first switching position, a flow-through position of the backup valve unit can be provided.

In the context of the present invention, a predeterminable amount of operating fluid or fluid may be understood to mean, in particular, a previously defined volume intended to be used for flushing or cleaning the first and/or second cylinder chamber.

The amount of fluid may, for example, be determined based on the expected level of cleaning, a cleaning/flushing duration, a minimum/maximum flow rate of the fluid, and/or similar factors.

It may be further provided that, after supplying the predeterminable amount of fluid, the first fluid connection is disconnected, with a pressure equalization between the first and second cylinder chambers preferably taking place via the second fluid connection.

In particular, the disconnection of the first fluid connection can be effected by switching the backup valve unit from the first switching position—a flow-through position—into the second switching position—a blocking position.

In this way, the normal operation of the fluid cylinder can be resumed and continued after the cleaning or flushing process of the first and/or second cylinder chamber.

It may further be provided that the actuator unit, in particular the motor vehicle, is brought or switched into a stationary position, preferably a park position, before the first fluid connection is established.

By setting a standby or park position of this kind, the fluid cylinder of the actuator unit, in particular of a Steering actuator unit, can be locked or fixed in place.

Consequently, outside normal or intended operation, safe cleaning or flushing of the fluid cylinder of the actuator unit can take place.

Furthermore, it is possible for a pressure equalization between the first and second cylinder chambers to be carried out after supplying the predeterminable amount of fluid, particularly for a predeterminable holding time.

In particular, a pressure equalization of this kind can be effected via the second fluid connection with at least one throttling unit between the first and second cylinder chambers.

With the help of the predeterminable holding time, it is possible to ensure that a sufficient pressure equalization has occurred or can occur between the two cylinder chambers before the recommissioning of the actuator unit. In this way, a sudden adjustment of the actuator unit following the flushing or cleaning process of the first and/or second cylinder chamber is avoided.

All structural and functional features associated with the actuator unit or motor vehicle according to the invention described above, as well as those related to possible embodiments, may also be provided or be present individually or in combination in the method according to the invention for operation, and the advantages associated therewith can be achieved.

Further details and advantages of the invention will now be explained in greater detail with the help of the exemplary embodiments shown in the drawings. In the drawings:

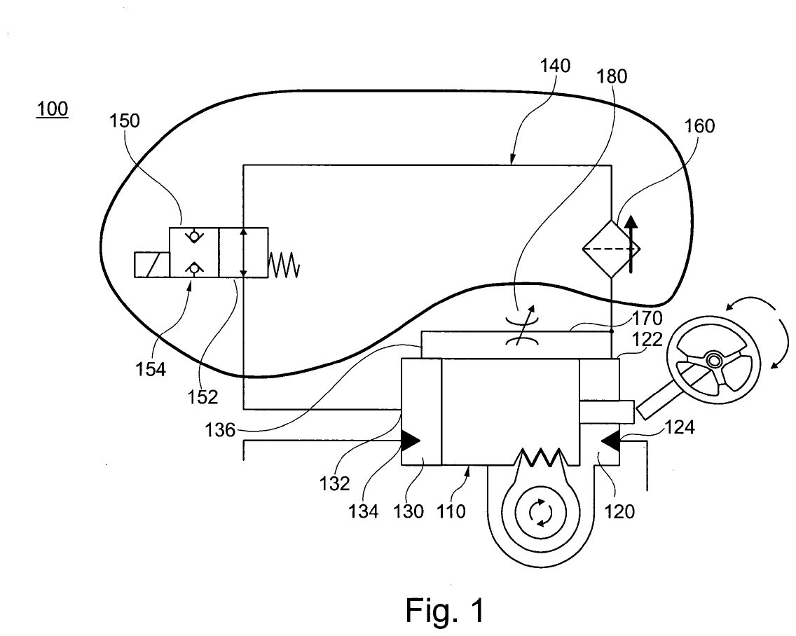

FIG. 1: shows a schematic view of a first exemplary embodiment of an actuator unit;

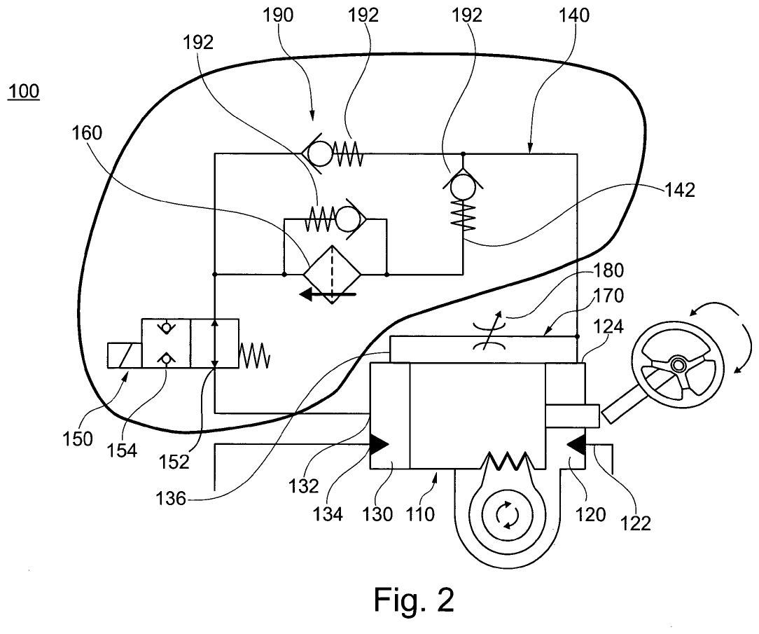

FIG. 2: shows a schematic view of a second exemplary embodiment of an actuator unit;

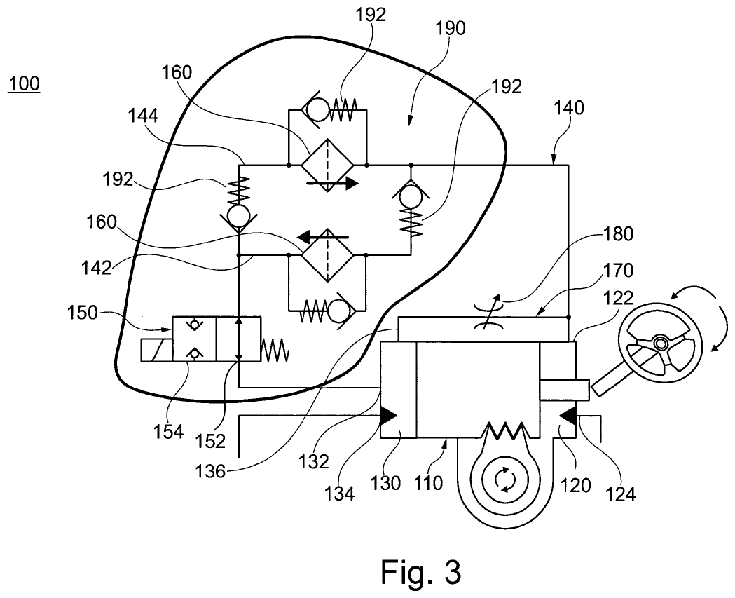

FIG. 3: shows a schematic view of a third exemplary embodiment of an actuator unit; and

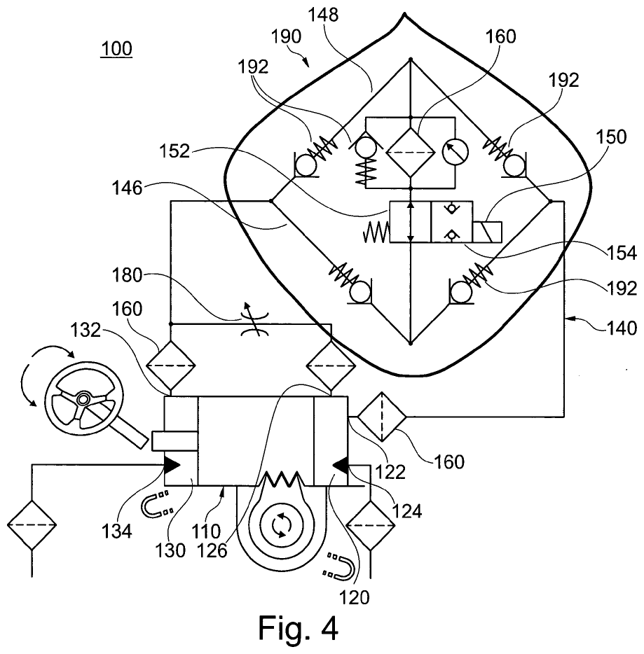

FIG. 4: shows a schematic view of a fourth exemplary embodiment of an actuator unit.

FIG. 1 shows a schematic view of a first exemplary embodiment of an actuator unit 100, in particular a steering actuator unit. Essentially, the exemplary embodiment according to FIG. 1 illustrates the basic principles of the present invention.

The actuator unit 100 is provided with at least one fluid cylinder 110 and at least one backup valve unit 150.

The fluid cylinder 110 may be configured with a first cylinder chamber 120 and a second cylinder chamber 130.

In particular, the fluid cylinder 110 according to FIG. 1 may be configured as a piston cylinder.

The first cylinder chamber 120 comprises a first flushing port 122 and a first fluid port 124. The second cylinder chamber 130 comprises a second flushing port 132 and a second fluid port 134.

The backup valve unit 150 is provided with a first switching position 152, preferably a flow-through position, and a second switching position 154, preferably a blocking position.

Furthermore, the backup valve unit 150 may preferably be formed as a spring-loaded solenoid valve, wherein the spring force preferably acts in the direction of the first switching position 152, so that the de-energized backup valve unit 150 is brought into the first switching position 152 by the spring force.

When the solenoid valve is (actively) switched to the second switching position 154, a fluid connection is preferably interrupted.

The backup valve unit 150 is arranged between the first and second cylinder chambers 120, 130, preferably to form or disconnect a first fluid connection 140.

In particular, a first fluid connection 140 between the first flushing port 122 of the first cylinder chamber 120 and the second flushing port 132 of the second cylinder chamber 130 can be established or disconnected with the help of the backup valve unit 150.

In this way, the first fluid connection 140 may have a first flow direction, from the first cylinder chamber 120 to the second cylinder chamber 130, and a second flow direction, from the second cylinder chamber 130 to the first cylinder chamber 120.

Furthermore, at least one filter unit 160 is arranged along the first fluid connection 140.

The filter unit 160 is arranged between the backup valve unit 150 and the first flushing port 122 of the first cylinder chamber 120 according to FIG. 1. In this way, in the first flow direction, the filter unit 160 can be arranged upstream of the backup valve unit 150, or, in the second flow direction, downstream of the backup valve unit 150.

Alternatively, the at least one filter unit 160 may be provided along the first fluid connection 140 between the backup valve unit 150 and the second flushing port 132 or the second cylinder chamber 130.

Furthermore, the fluid cylinder 110 may have a second fluid connection 170, preferably with a throttling unit 180.

The second fluid connection can be formed between the first flushing port 122 and a throttle port 136 of the second cylinder chamber 130.

Alternatively, the second fluid connection 170 may be formed between the second flushing port 132 and a throttle port of the first cylinder chamber 120, or between two throttle ports of the first and second cylinder chambers 120, 130.

FIG. 2 shows schematically another possible embodiment of an actuator unit 100. Compared with the exemplary embodiment according to FIG. 1, the exemplary embodiment according to FIG. 2 exhibits the following differences in particular.

A rectifier circuit 190 is provided along the first fluid connection 140, particularly in the form of a half-wave rectifier circuit.

The rectifier circuit 190 according to FIG. 2 is configured with a plurality of check valves 192.

In particular, the filter unit 160 may be provided arranged within the rectifier circuit 190 or integrated therein.

The rectifier circuit 190 can preferably be arranged along the first fluid connection 140 between the first flushing port 122 and the backup valve unit 150, i.e. preferably upstream of the backup valve unit 150 in the first flow direction.

According to FIG. 2 it is provided that the first fluid connection 140 includes, in sections, a parallel configuration or at least a first parallel branch 142.

The filter unit 160 may be arranged along the first parallel branch 142.

Along the first parallel branch 142, a check valve 192 with an open position in the first flow direction and a blocking position in the second flow direction can be arranged upstream of the filter unit 160 in the first flow direction.

Furthermore, another check valve 192 may be arranged in parallel with the filter unit 160 along the first parallel branch 142, which check valve preferably has a blocking position in the second flow direction and an open position in the first flow direction.

Furthermore, a check valve is arranged in parallel to the first parallel branch 142 along the first fluid connection 140, wherein the check valve preferably adopts a blocking position in the first flow direction and an open position in the second flow direction.

With the help of the check valves 192 of the rectifier circuit 190 according to FIG. 2, a fluid flow in the first flow direction through the filter unit 160 can be guaranteed, wherein bypassing or short-circuiting the filter unit 160 is prevented. By contrast, a fluid flow in the second flow direction, i.e. from the second cylinder chamber 130 to the first cylinder chamber 120, is routed past the filter unit 160.

In particular, the embodiment according to FIG. 2 is provided to enable flushing or cleaning of the first cylinder chamber 120; 130, wherein contamination or deposits can be removed from, or filtered out of, the fluid with the help of the filter unit 160.

FIG. 3 shows a further exemplary embodiment of an actuator unit 100 that differs from the embodiment according to FIG. 2 particularly as follows.

According to FIG. 3, the actuator unit 100 comprises a rectifier circuit 190 in the form of a full-wave rectifier circuit.

In particular, the rectifier circuit 190 according to FIG. 3 can be understood or interpreted as a duplication or mirror image of the half-wave rectifier circuit from FIG. 2 along the first fluid connection 140.

The first fluid connection 140 can therefore be configured along the rectifier circuit 190 with a first parallel branch 142 and a second parallel branch 144.

Just like the first parallel branch according to FIG. 2, the second parallel branch 144 according to FIG. 3 also includes a filter unit 140 with a check valve 192 connected in series, as well as an additional check valve 192 arranged parallel to the filter unit 190.

The check valve 192 connected in series in the second parallel branch 144 preferably has a blocking position in the first flow direction and an open position in the second flow direction of the first fluid connection 140. The check valve connected in parallel to the filter unit 160 along the second parallel branch 144 is preferably in a blocking position in the first flow direction and in an open position in the second flow direction.

With the help of the check valves 192 along the first and second parallel branches 142, 144 it is possible to ensure that in the first and second flow direction respectively, a specific one of the two filter units 160 must, or can, be flowed through (cf. arrow directions in FIG. 3).

Consequently, it is provided, as shown in FIG. 3, that the fluid can be filtered in the first flow direction along the first parallel branch 142, and can be filtered in the second flow direction along the second parallel branch 144.

The check valves connected in parallel to the respective filter units 160 preferably allow an emergency bypass of the filter units 160, e.g. in the event of clogging or blockage of the filter units 160.

FIG. 4 shows a schematic representation of a further embodiment of an actuator unit 100 that differs from the embodiments according to FIGS. 2 and 3, in particular as described below.

The rectifier circuit 190 in FIG. 4 is designed as what is known as a Graetz circuit.

In particular, the rectifier circuit 190 according to FIG. 4 has a first and a second fluid branch 146, 148, along each of which two successive check valves 192 are arranged.

A bridge connection for connecting the first and second branches 146, 148 is provided between the two check valves 192 of the first and second branches 146, 148.

The backup valve unit 150 and the filter unit 160 are arranged in series along the bridge connection.

In parallel to the filter unit 160, an additional check valve 192 may be provided as an emergency bypass in the event of clogging of the filter unit 160.

Furthermore, a fluid pressure gauge may be provided parallel to the filter unit 160 in FIG. 4.

The two successive check valves 192 along the first and second fluid branches 146, 148 are each arranged in such a manner that they have mutually opposite blocking and open positions.

In particular, the check valves 192 along the first branch 146 are arranged or have an open position in such a manner that a respective fluid flow can be routed via the bridge connection of the rectifier circuit 190 in the first or second flow direction.

The check valves 192 of the second fluid branch 148 are arranged with an open or blocking position in such a manner that a fluid flow in the first or second flow direction can reach the bridge connection via one of the two check valves 192, in order to be routed via the filter unit 160 and the backup valve unit 150.

With the help of the rectifier circuit 190 according to FIG. 4, in particular in the form of a Graetz circuit, it is possible to ensure that a fluid flow in the first and in the second flow direction can always pass through the filter unit 160 and the backup valve unit in the same direction.

In particular, as shown in FIG. 4, provision is made for fluid to flow through the two check valves 192 along the second fluid branch 148 in each case in the direction of the bridge connection or the filter unit 160.

Along the first fluid branch 146, on the other hand, the two check valves 192 are switched in opposite directions in such a manner that the fluid can continue to flow from the bridge connection in the first or second flow direction. Continuation of the respective flow direction or current direction, starting from the first cylinder chamber 120 or the second cylinder chamber 130, is in particular also assisted or caused by the counterpressure present at the respective check valve 192, originating from the first cylinder chamber 120 in the case of the first flow direction or from the second cylinder chamber 130 in the case of the second flow direction.

This means that with the help of the (full) rectifier circuit according to FIG. 4, as with FIG. 3, flushing or cleaning of both the first and the second cylinder chamber 120, 130 can be guaranteed.

Further filter units 160 may also be provided along the first fluid connection 140 in FIG. 4, in particular close to the first and/or second flushing connection 122, 132 of the fluid cylinder 110.

It is also envisaged in FIG. 4 that the second fluid connection, in addition to at least one throttle unit 180, comprises at least one filter unit 160, preferably close to or between a throttle connection 126 of the first cylinder chamber 120 and the throttle unit 180.

The basic function of the actuator unit 100 can be described as follows:

A fluid can be introduced via the first fluid connection 124 into the first cylinder chamber 120, in order to pass via the first flushing connection 122 into the first fluid connection 140 and from there into the second cylinder chamber 130. In this way, the first cylinder chamber 120 can be flushed or cleaned, so that contamination or deposits can be removed from the cylinder chamber 120. Alternatively, a fluid or a predeterminable amount of fluid can be introduced into the second cylinder chamber 130 via the second fluid connection, in order to clean or flush the second cylinder chamber, wherein the fluid is routed via the first fluid connection 140 into the first cylinder chamber 120.

The fluid that is additionally introduced can, for example, be discharged via the respective fluid connection 124, 134 of the respective opposite cylinder chamber 120, 130.

Particularly preferably, the filter unit 160 is positioned along the first fluid connection 140 relative to the backup valve unit 150 in such a manner that the filter unit 160 can protect the backup valve unit 150 from at least a substantial proportion of contamination or deposits from the first or second cylinder chamber 120, 130.

In summary, the present invention provides an actuator unit 100 which allows temporary cleaning or flushing of one or more cylinder chambers 120, 130 of a fluid cylinder 110, wherein contamination or deposits from the cylinder chambers 120, 130 can be retained or filtered from the fluid by a filter unit 160.

By arranging the filter unit 160, or providing a rectifier circuit 190 with an integrated filter unit 160, along the first fluid connection 140, advantageous filtration of the fluid can be achieved, wherein the backup valve unit 150 can preferably be protected against residue or contamination of this kind by the filter unit 160, at least in one of the first or second flow directions between the first and second cylinder chambers 120, 130.

Furthermore, various configurations of a rectifier circuit 190 make it possible to ensure filtration or cleaning in both flow directions, where appropriate with a single filter unit 160.

Additional filter units 160 may, in particular, be provided along the first fluid connection 140, in order to protect further check valves 192 and/or the backup valve unit from contamination or deposits from the first or second cylinder chamber 120, 130.

Furthermore, the configuration of the first fluid connection 140 may be such that an emergency bypass of the filter unit(s) 160 can occur exclusively or primarily in the event of clogging or blockage of a filter unit 160.

### LIST OF REFERENCE SIGNS

100 actuator unit
110 fluid cylinder
120 first cylinder chamber
122 first flushing port
124 first fluid port
130 second cylinder chamber
132 second flushing port
134 second fluid port
136 throttle port
140 first fluid connection
142 first parallel branch
144 second parallel branch
146 first fluid branch
148 second fluid branch
150 backup valve unit
152 first switching position
154 second switching position
160 filter unit
170 second fluid connection
180 throttle unit
190 rectifier circuit
192 check valve

1. An actuator unit, in particular a steering actuator unit, comprising at least one fluid cylinder, at least one backup valve unit, and at least one filter unit,
wherein the fluid cylinder comprises a first cylinder chamber and a second cylinder chamber,
wherein at least one first fluid connection can be formed, in particular at least temporarily formed, between the first and second cylinder chambers,
wherein the first fluid connection extends via the filter unit and the backup valve unit,
wherein a flushing function can be provided via the first fluid connection, in particular for flushing out contaminants and/or deposits, for the first cylinder chamber (120) in a first flow direction of the first fluid connection (140) and/or for the second cylinder chamber in a second flow direction of the first fluid connection.

2. The actuator unit as claimed in claim 1, wherein the filter unit is provided along the first fluid connection in such a manner that the filter unit is arranged between the backup valve unit and the first cylinder chamber or the second cylinder chamber, in particular between the backup valve unit and that cylinder chamber which has at least a substantial proportion of the contamination and/or deposits.

3. The actuator unit as claimed in claim 1, wherein the fluid cylinder comprises a first fluid port and a first flushing port, as well as a second fluid port and a second flushing port,
wherein the first and second flushing ports are provided for forming the first fluid connection.

4. The actuator unit as claimed in claim 1, wherein a second fluid connection is provided between the first and second cylinder chambers,
wherein the second fluid connection comprises a throttle unit.

5. The actuator unit as claimed in claim 1, wherein at least the first cylinder chamber or the second cylinder chamber comprises a throttle port, so that the second fluid connection is preferably formed between the throttle port and the first or second flushing port.

6. The actuator unit as claimed in claim 1, wherein the backup valve unit is a spring-loaded solenoid valve, wherein the backup valve unit comprises at least a first switching position, preferably a flow-through position, and a second switching position, preferably a blocking position.

7. The actuator unit as claimed in claim 1, wherein the fluid cylinder is designed as a double-acting fluid cylinder, in particular as a double-acting piston cylinder.

8. The actuator unit as claimed in claim 1, wherein the actuator unit further comprises a rectifier circuit,
wherein the backup valve unit and/or the filter unit are arranged within the rectifier circuit, in particular so that a flushing function for the first and/or second cylinder chamber is provided along the first fluid connection.

9. The actuator unit as claimed in wherein the rectifier circuit within the first fluid connection is configured as a half-wave rectifier circuit, to provide a flushing function for one of the first or second cylinder chambers, or as a full-wave rectifier circuit, to provide a flushing function for the first and second cylinder chambers.

10. The actuator unit as claimed in claim 8, wherein the rectifier circuit is formed with a plurality of check valves, in such a manner that the flushing function can be predetermined in the first and/or second flow direction along the first fluid connection.

11. A motor vehicle, in particular a commercial vehicle, comprising at least one actuator unit as claimed in claim 1.

12. A method for operating at least one actuator unit or a motor vehicle as claimed in claim 1, comprising the following steps:
establishing the first fluid connection between the first and second cylinder chambers, in particular by means of switching the backup valve unit from the first switching position into the second switching position
supplying a predeterminable amount of fluid via at least the first or second fluid port into the first or second cylinder chamber, so that a flushing function is provided via the first fluid connection in the first or second flow direction.

13. The method as claimed in claim 12, wherein after supplying the predeterminable amount of fluid, the first fluid connection is disconnected, wherein a pressure equalization between the first and second cylinder chambers preferably takes place via the second fluid connection.

14. The method as claimed in claim 12, wherein the actuator unit, in particular the motor vehicle, is brought into a stationary position, preferably into a park position, before the first fluid connection is established.

15. The method as claimed in claim 12, wherein after supplying the predeterminable amount of fluid, a pressure equalization between the first and second cylinder chambers takes place, in particular for a predeterminable holding time.
